(19) United States
(12) Patent Application Publication
(10) Pub. No.: US 2021/0297430 A1
(43) Pub. Date: Sep. 23, 2021

(54) VEHICLE CONTROL APPARATUS

(71) Applicant: Honda Motor Co., Ltd., Tokyo (JP)

(72) Inventors: Ryosuke Oguchi, Wako-shi (JP); Yoshiyuki Amanuma, Wako-shi (JP); Kensuke Yamamoto, Wako-shi (JP); Ryoji Nishimoto, Wako-shi (JP); Kazuki Sakuma, Wako-shi (JP)

(21) Appl. No.: 17/202,101

(22) Filed: Mar. 15, 2021

(30) Foreign Application Priority Data
Mar. 23, 2020 (JP) 2020-051602

(51) Int. Cl. H04L 29/06; H04L 29/08; B60W 10/08; B60W 10/20; B60K 35/00; B60W 50/00

(52) U.S. Cl. CPC H04L 63/1416; H04L 67/12; B60W 10/08; B60K 2370/167; B60K 35/00; B60W 50/0098; B60W 10/20

(57) ABSTRACT

A vehicle control apparatus includes: a steering control unit connected to an in-vehicle communication network mounted on a vehicle and configured to control a steering motor configured to add an auxiliary torque corresponding to a steering operation by a driver to a steering mechanism; and an illegal signal detection unit connected to the in-vehicle communication network and configured to detect an illegal signal input to the in-vehicle communication network. The steering control unit restricts the auxiliary torque when the illegal signal is detected by the illegal signal detection unit.

### CROSS-REFERENCE TO RELATED APPLICATION

This application is based upon and claims the benefit of priority from Japanese Patent Application No. 2020-051602 filed on Mar. 23, 2020, the content of which is incorporated herein by reference.

### BACKGROUND OF THE INVENTION

### Field of the Invention

This invention relates to a vehicle control apparatus for controlling steering mechanism of vehicle.

### Description of the Related Art

Conventionally, a device that detects a denial of service (DoS) attack from a device outside a vehicle to an in-vehicle communication network is known (see, for example, JP 2016-143963 A). In the device described in JP 2016-143963 A, when it is determined that a DoS attack has occurred, the gateway stops relaying the data signal to each electronic control unit.

However, in the device described in JP 2016-143963 A, the gateway only stops the relay of the data signal when the DoS attack is determined, and the influence of the illegal signal input by the time of the determination on the vehicle is not considered. Therefore, there is a risk that unnecessary auxiliary torque is generated in the steering mechanism of the vehicle and unintended steering force is generated by these signals.

### SUMMARY OF THE INVENTION

An aspect of the present invention is a vehicle control apparatus, including: a steering control unit connected to an in-vehicle communication network mounted on a vehicle and configured to control a steering motor configured to add an auxiliary torque corresponding to a steering operation by a driver to a steering mechanism; and an illegal signal detection unit connected to the in-vehicle communication network and configured to detect an illegal signal input to the in-vehicle communication network. The steering control unit restricts the auxiliary torque when the illegal signal is detected by the illegal signal detection unit.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example of an in-vehicle communication network having a vehicle control apparatus according to an embodiment of the present invention;

FIG. 2 is a diagram illustrating a data frame input to a gateway in FIG. 1;

FIG. 3 is a block diagram schematically illustrating a configuration of main parts of each unit of the in-vehicle communication network in FIG. 1;

FIG. 4 is a flowchart illustrating an example of a process for an illegal data frame executed by the gateway in FIG. 3;

FIG. 5 is a block diagram illustrating main part configuration of a modification of the vehicle control apparatus according to the embodiment of the present invention; and

FIG. 6 is a flowchart illustrating an example of a process for an illegal data frame executed by a steering control ECU in FIG. 5.

### DETAILED DESCRIPTION OF THE INVENTION

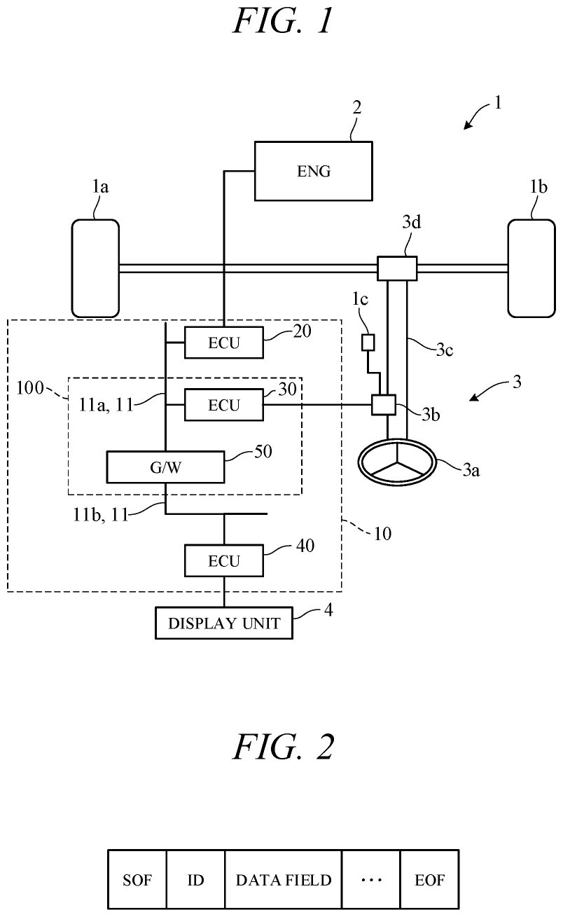

An embodiment of the present invention will be described below with reference to FIGS. 1 to 4. FIG. 1 is a diagram schematically illustrating an example of an in-vehicle communication network 10 having a vehicle control apparatus 100 according to an embodiment of the present invention. As illustrated in FIG. 1, the in-vehicle communication network 10 includes an engine control unit (ECU) (engine control unit) 20 that controls an engine 2 of a vehicle 1, a steering control ECU 30 that controls a steering device 3, a display control ECU (display control unit) 40 that controls a display unit 4 on an instrument panel, and a gateway 50 that relays communication among the ECUs 20, 30, and 40 and communication with the outside of the vehicle (transmission and reception of data signals). The vehicle control apparatus 100 according to an embodiment of the present invention can be composed of a gateway 50 and a steering control ECU 30. That is, it is possible to configure that the functions of the vehicle control apparatus 100 are distributed to the gateway 50 and the steering control ECU 30. In the following, an example in which the vehicle control apparatus 100 is composed of the gateway 50 and the steering control ECU 30 will be described.

The engine control ECU 20, the steering control ECU 30, the display control ECU 40, and the gateway 50 are communicatively connected to each other via a serial communication line 11 such as a controller area network (CAN) communication line and the like. More specifically, the engine control ECU 20 and the steering control ECU 30, which constitute a control system communication network of the vehicle 1, and the gateway 50 are mutually communicably connected via a serial communication line 11a, and the engine control ECU 20 and the steering control ECU 30 perform cooperative control by mutually transmitting and receiving data signals via the serial communication line 11a. The display control ECU 40 that constitutes an information system communication network of the vehicle 1 and a gateway 50 are mutually communicably connected via a serial communication line 11b. The engine control ECU 20, the steering control ECU 30, and the display control ECU 40 perform cooperative control by mutually transmitting and receiving data signals via the gateway 50.

FIG. 2 is a diagram illustrating a data frame input to the gateway 50. Data signals input from each of the ECUs 20, 30, and 40 and data signals input from the outside of the vehicle are input as one data frame to the gateway 50. As illustrated in FIG. 2, the data frame includes a start of frame (SOF) indicating the start of the data frame, an identification (ID) indicating identification information such as a transmission source, a transmission destination, and the like, a data field being substantial data, an end of frame (EOF) indicating the end of the data frame, and the like.

The engine control ECU 20 and the steering control ECU 30 receive, from the data frame input to the serial communication line 11a, only the data frame including the ID to be received, which is set in advance, based on the ID of each data frame. Thus, for example, the steering control ECU 30 receives the engine speed transmitted from the engine control ECU 20 and uses it for processing of the next calculation cycle, so as to achieve cooperative control between the steering control ECU 30 and the engine control ECU 20. At this time, the data frame is also inputted to the gateway 50, and the gateway 50 also manages to relay the data frame by each of the ECUs 20 and 30.

Similarly, the engine control ECU 20, the steering control ECU 30, and the display control ECU 40 receive, from the data frame input to the serial communication lines 11a and 11b, only the data frame including the ID to be received, which is set in advance, based on the ID of each data frame. Thus, for example, the steering control ECU 30 receives the display information transmitted from the display control ECU 40 and uses it for arithmetic processing, so as to achieve cooperative control between the steering control ECU 30 and the display control ECU 40. At this time, the gateway 50 manages to relay the data frame by each of the ECUs 20, 30, and 40.

In such an in-vehicle communication network 10, a large number of illegal data frames are transmitted (input) by a malicious third party, which may result in an attack in which transmission or reception of normal data frames is hindered, that is, a so-called DoS attack. If such a DoS attack occurs, the ECUs 20 30, and 40 connected to the in-vehicle communication network 10 may not operate normally, so that the gateway 50 stops relaying the data frames. On the other hand, until the gateway determines that a DoS attack has occurred, an illegal data frame is transmitted to the in-vehicle communication network 10, and there is a risk that this illegal data frame may cause the steering control ECU 30 to generate an unintended steering force. Therefore, the vehicle control apparatus 100 according to the embodiment of the present invention is configured as follows so as to prevent generating unintended steering force.

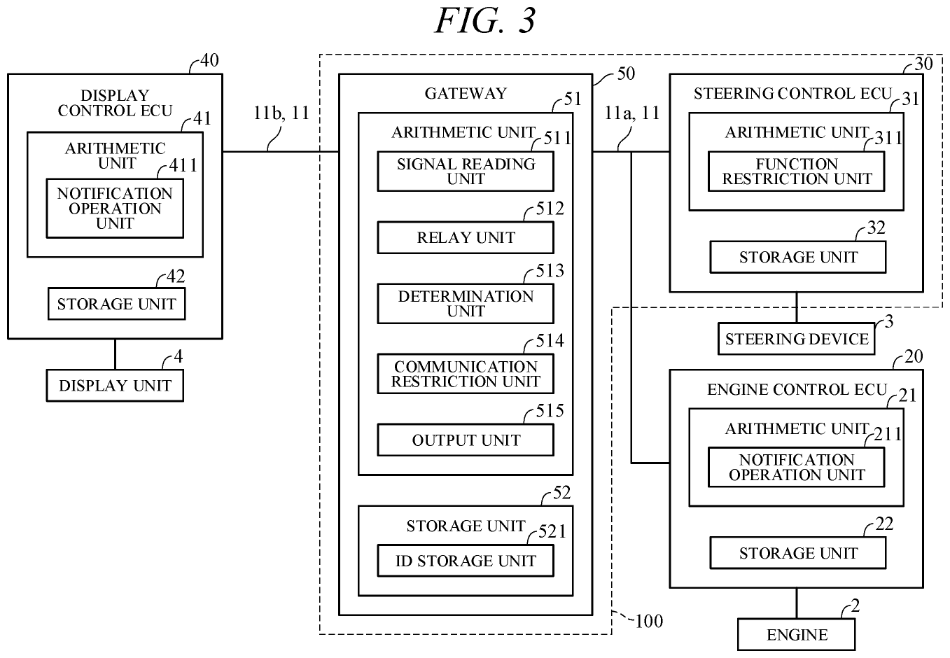

FIG. 3 is a block diagram schematically illustrating a configuration of the main parts of each unit of the in-vehicle communication network 10 of FIG. 1. As illustrated in FIG. 3, the gateway 50 includes a computer including an arithmetic unit 51 such as a central processing unit (CPU) or the like, a storage unit 52 such as a read-only memory (ROM), a random-access memory (RAM), a hard disk drive, and the like, and other peripheral circuits. The arithmetic unit 51 includes, as a functional configuration, a signal reading unit 511, a relay unit 512, a determination unit 513, a communication restriction unit 514, and an output unit 515. The storage unit 52 includes an ID storage unit 521 as a functional configuration.

A signal reading unit 511 reads all the data frames inputted to the in-vehicle communication network 10. The data frames to be read include not only data frames input from the ECUs 20, 30, and 40 inside the vehicle, but also data frames input from the outside of the vehicle via a data link connector (DLC) not illustrated in the drawings that can be connected to a telematics control unit (TCU) that performs wireless communication, a diagnostic machine, and the like not illustrated in the drawings.

The relay unit 512 relays the data frame read by the signal reading unit 511 to the ECUs 20, 30, and 40. More specifically, the relay unit 512 identifies a transmission destination based on the ID of the data frame read by the signal reading unit 511 and transfers (relays) the data frame to the identified transmission destination.

A determination unit 513 determines whether or not the data frame read by the signal reading unit 511 is an illegal data frame. The determination unit 513 determines whether or not the read data frame is an illegal data frame based on an ID list which will be described later stored in the ID storage unit 521. For example, the determination unit 513 determines that a data frame having an ID not included in the ID list in which the legal IDs are preliminarily listed is an illegal data frame. Also, the determination unit 513 determines that the data frame is an illegal data frame when the transmission source is an unknown ID, when the ID is an ID of a transmission source that exists but is not supposed to transmit it originally, or when the data frame having that ID is received in a cycle shorter than the stored transmission cycle by storing an approximate transmission cycle together with the ID received by itself. Further, the determination unit 513 can also determine whether or not the data frame is an illegal data frame input from a tampered ECU or an illegal external device by a known method and perform the determination based on the result.

When the determination unit 513 determines that the data frame is an illegal data frame, the communication restriction unit 514 restricts the communication of in-vehicle communication network 10. More specifically, the communication restriction unit 514 prohibits (stops) relaying of data frames to the ECUs 20, 30, and 40 in the in-vehicle communication network 10 and blocks communication between the in-vehicle communication network 10 and the outside of the vehicle.

When the determination unit 513 determines that the data frame is an illegal data frame, the output unit 515 transmits a data frame for instructing the function restriction to the steering control ECU 30. The output unit 515 generates a message authentication code (MAC) by encrypting the data frame of the function restriction command by a MAC algorithm using a MAC key and transmits the generated MAC to the steering control ECU 30 together with the data frame of the function restriction command. By transmitting the data frame to which the MAC is added, it is possible to prevent falsification of the data frame.

When the determination unit 513 determines that the data frame is an illegal data frame, the output unit 515 transmits to the engine control ECU 20 and the display control ECU 40 a notification command data frame for commanding a predetermined notification operation of notifying the driver of the vehicle 1 of that the auxiliary torque (assist of steering power) by the steering device 3 is to be restricted. For example, the output unit 515 outputs the data frame of the first notification command to the engine control ECU 20 and outputs the data frame of the second notification command to the display control ECU 40. Upon receiving the data frame of the first notification command, the engine control ECU 20 performs control to lower the rotational speed of the engine 2 of the vehicle 1 so as to lower the vehicle speed. By lowering the engine speed and the vehicle speed, it is possible to make the driver of the vehicle 1 recognize that some abnormality has occurred. Upon receiving the data frame of the second notification command, the display control ECU 40 performs control to cause the display unit 4 disposed on the instrument panel of the vehicle 1 to display a warning lamp indicating the occurrence of the restriction of the auxiliary torque. Note that, before transmitting the data frame of the function restriction command to the steering control ECU 30, the output unit 515 transmits the data frames of the first and second notification commands to the engine control ECU 20 and the display control ECU 40.

The ID storage unit 521 stores an ID list in which the IDs (legal IDs) of legal ECUs are listed. The legal ID is set in each ECU of the vehicle 1 together with the vehicle ID, when the vehicle 1 was manufactured, and is different for each ECU.

As illustrated in FIG. 3, the steering control ECU 30 includes a computer including an arithmetic unit 31 such as a CPU or the like, a storage unit 32 such as a ROM, a RAM, a hard disk drive, and the like, and other peripheral circuits. The arithmetic unit 31 includes a function restriction unit 311 as a functional configuration. Upon receiving the data frame of the function restriction command output from the output unit 515 of the gateway 50, the function restriction unit 311 restricts the assist function for steering (rotation operation of the steering wheel 3a) using the steering device 3 by the driver. For example, the generation amount of the auxiliary torque added to the steering mechanism is reduced to reduce the assist function of steering.

Here, the steering device 3 will be briefly described with reference to FIG. 1. As illustrated in FIG. 1, the steering device 3 includes a steering wheel 3a performed rotation operation by a driver, a steering motor 3b, a steering shaft 3c rotated integrally with the steering wheel 3a, and a steering gear box 3d for turning wheels 1a and 1b according to the rotation of the steering shaft 3c. The steering wheel 3a, the steering shaft 3c, and the steering gear box 3d constitute the steering mechanism, and the steering motor 3b adds the auxiliary torque corresponding to the rotation of the steering wheel 3a to the steering shaft 3c to assist the rotation operation of the steering wheel 3a by the driver. For example, the steering motor 3b imparts a rotational force that facilitates rotation of the steering wheel 3a and imparts a rotational force so as to impart a large operation reaction force to the driver as the operation amount of the steering wheel 3a increases. To prevent the driver from unnecessarily rotating a steering wheel 3a excessively by generating the operation reaction force in accordance with the operation amount of the steering wheel 3a.

The steering motor 3b is connected to a battery 1c via an inverter (not illustrated in the drawings) and driven by power supplied from the battery 1c. In the steering motor 3b, power supplied from the battery 1c is controlled by the function restriction unit 311. That is, the function restriction unit 311 controls the driving of the steering motor 3b and controls the auxiliary torque added to the steering shaft 3c.

When receiving the data frame of the function restriction command, the function restriction unit 311 controls the supply of power to the steering motor 3b so that the power supplied to the steering motor 3b is reduced to be lower than before receiving the data frame of the function restriction command. That is, when receiving the data frame of the function restriction command, the function restriction unit 311 reduces the auxiliary torque added to the steering shaft 3c by reducing the power supply to the steering motor 3b. Thus, for example, even when there is a risk that the steering motor 3b may cause unnecessary operation due to an illegal data frame input to the in-vehicle communication network 10, since the auxiliary torque added to the steering shaft 3c is reduced, the assist amount by the steering motor 3b is prevented from rapidly changing, and it is possible to prevent unintended steering from occurring.

When receiving the data frame of the function restriction command, the function restriction unit 311 may stop supplying the power to the steering motor 3b. By stopping the power supply to the steering motor 3b and stopping the steering assist function by the steering motor 3b, it is possible to prevent the unintended steering from occurring more surely.

As illustrated in FIG. 3, the engine control ECU 20 includes a computer including an arithmetic unit 21 such as a CPU or the like, a storage unit 22 such as a ROM, a RAM, a hard disk drive, and the like, and other peripheral circuits. The arithmetic unit 21 includes a notification operation unit 211 as a functional configuration. When receiving the data frame of the first notification command output from the output unit 515 of the gateway 50, the notification operation unit 211 performs control to reduce the rotational speed of the engine 2 so that the vehicle speed of the vehicle 1 is reduced. The driver of the vehicle 1 can recognize that there is a risk that some abnormality has occurred due to the decrease in the vehicle speed and can also easily cope with the restriction of the steering assist function occurring thereafter.

The display control ECU 40 includes a computer including an arithmetic unit 41 such as a CPU or the like, a storage unit 42 such as a ROM, a RAM, a hard disk drive, and the like, and other peripheral circuits. The arithmetic unit 41 includes a notification operation unit 411 as a functional configuration. When receiving the data frame of the second notification command output from the output unit 515 of the gateway 50, the notification operation unit 411 controls the display unit 4 so that the warning light of the assist restriction of the steering force is displayed on the display unit 4 arranged on the instrument panel of the vehicle 1. The driver of the vehicle 1 can also easily cope with the restriction of the steering assist function occurring thereafter by displaying the warning lamp of the steering assist restriction on the display unit 4.

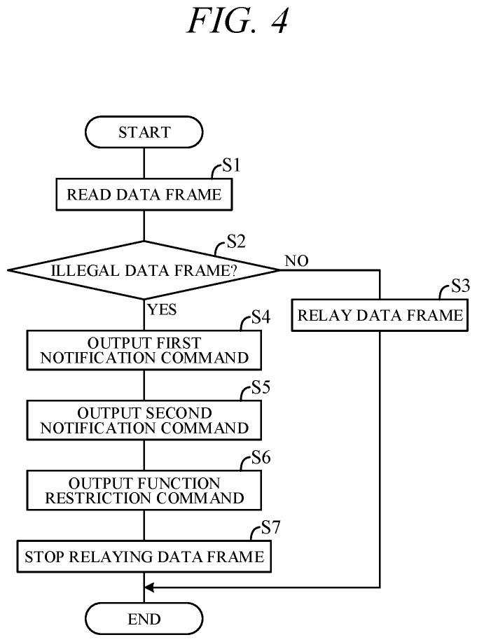

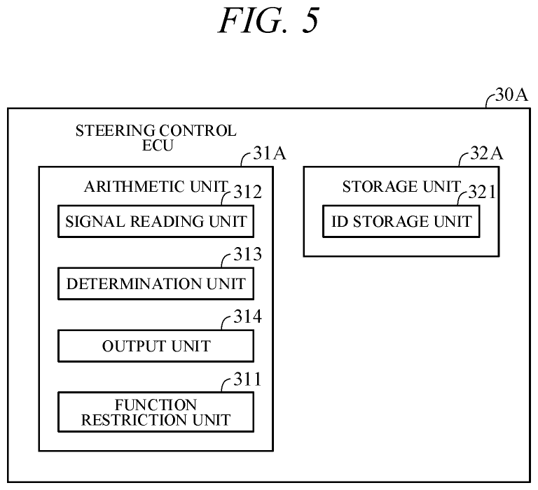

FIG. 4 is a flowchart illustrating an example of a process for an illegal data frame executed by the gateway 50 of FIG. 3. The process illustrated in FIG. 4 is started when inputting a data frame to the serial communication lines 11a and 11b and is repeatedly executed.

First, in S1 (S: processing step), an ID (identification information) of the input data frame is read by the processing in the signal reading unit 511. Next, in S2, it is determined whether or not the input data frame is an illegal data frame by the processing in the determination unit 513. If the result is negative in S2, in S3, the data frame is transferred (relayed) to the transmission destination based on the ID of the data frame by the processing in the relay unit 512.

On the other hand, if it is affirmed in S2, in S4, the data frame of the first notification command is output to the engine control ECU 20 by the processing in the output unit 515. Next, in S5, the data frame of the second notification command is output to the display control ECU 40 by the processing in the output unit 515. Note that steps S4 and S5 may be executed simultaneously or in reverse order.

Next, in S6, the data frame of the function restriction command to the steering control ECU 30 by the processing in the output unit 515. Next, in S7, by the processing in the communication restriction unit 514, the relay of the data frame to the ECUs 20, 30, and 40 of the in-vehicle communication network 10 is prohibited (stopped), and the communication between the in-vehicle communication network 10 and the outside of the vehicle is interrupted.

The main operation of the vehicle control apparatus 100 according to the present embodiment will be described. When detecting an illegal data frame from the data frame (data signal) input to the in-vehicle communication network 10 (S2), the gateway 50 transmits the data frame of the function restriction command to the steering control ECU 30 (S6). When receiving the data frame of the function restriction command, the steering control ECU 30 controls the supply of power to the steering motor 3b so that the power supplied to the steering motor 3b is reduced to be lower than before receiving the data frame of the function restriction command.

At this time, before transmitting the data frame of the function restriction command to the steering control ECU 30, the gateway 50 transmits the data frame of the notification command for instructing the notification operation to the engine control ECU 20 and the display control ECU 40.

According to the present embodiment, it is possible to achieve advantages and effects such as the following:

(1) A vehicle control apparatus 100 includes: a steering control ECU 30 that is connected to an in-vehicle communication network 10 mounted on a vehicle 1 and controls a steering motor 3b that adds auxiliary torque corresponding to steering operation to a steering mechanism; and a gateway 50 that detects an illegal signal input to the in-vehicle communication network 10. The steering control ECU 30 restricts the auxiliary torque by the steering motor 3b when the data frame input to the in-vehicle communication network 10 by the gateway 50 is determined to be an illegal data frame (an illegal data frame is detected).

With this configuration, even when there is a risk that the steering motor 3b may cause unnecessary operation due to an illegal data frame input to the in-vehicle communication network 10, since the auxiliary torque added to the steering shaft 3c is restricted, for example, the assist amount by the steering motor 3b is restricted to not changing rapidly, and it is possible to prevent unintended steering from occurring.

(2) When the gateway 50 determines that the data frame is illegal, the steering control ECU 30 controls the supply of power to the steering motor 3b so that power supplied to the steering motor 3b is reduced to be lower than when the illegal data frame is not detected. Thus, since the auxiliary torque added to the steering shaft 3c is reduced, the assist amount by the steering motor 3b is suppressed from being rapidly changed. As a result, it is possible to prevent unintended steering from occurring.

(3) The steering control ECU 30 stops the supply of power to the steering motor 3b when an illegal signal is detected by the gateway 50. Thus, by stopping the power supply to the steering motor 3b and stopping the steering assist function by the steering motor 3b, it is possible to prevent the unintended steering from occurring more surely.

(4) The steering control ECU 30 restricts the auxiliary torque by the steering motor 3b after the notification operation for notifying the driver of the torque restriction of the steering motor 3b is performed. As a result, the driver of the vehicle 1 can recognize that there is a risk that some abnormality has occurred due to the occurrence of the notification operation and can also easily cope with the restriction of the steering assist function occurring thereafter.

(5) The engine control ECU 20 that controls the rotational speed of the engine 2 of the vehicle 1 is connected to the in-vehicle communication network 10. The steering control ECU 30 restricts the auxiliary torque by the steering motor 3b after the notification operation in which the engine control ECU 20 lowers the rotational speed of the engine 2. As a result, the driver of the vehicle 1 can recognize that there is a risk that some abnormality has occurred due to the decrease in the vehicle speed by lowering the rotational speed of the engine 2 and can also easily cope with the restriction of the steering assist function occurring thereafter. In particular, by lowering the vehicle speed, it becomes easy to recognize that there is a risk that some abnormality has occurred.

(6) The display control ECU 40 that controls the display of the display unit 4 on the instrument panel of the vehicle 1 is connected to the in-vehicle communication network 10. The steering control ECU 30 restricts the auxiliary torque by the steering motor 3b after the notification operation in which the display control ECU 40 displays a predetermined indication on the display unit 4. As a result, the driver of the vehicle 1 can also easily cope with the restriction of the steering assist function occurring thereafter by displaying the warning lamp of the steering assist stop on the display unit 4. In particular, when being displayed on the display unit 4, it becomes possible to easily recognize that there is a risk that some abnormality has occurred.

FIG. 5 is a block diagram illustrating a main part configuration of a modification of the vehicle control apparatus according to the embodiment of the present invention. In the embodiment described above, the vehicle control apparatus is composed of the steering control ECU 30 and the gateway 50, but it is possible to mount the functions that the vehicle control apparatus has only on the steering control ECU. In the following, an example in which the function that the vehicle control apparatus has is mounted only on the steering control ECU will be described. Note that, in the following description, differences from the steering control ECU 30 are mainly described, and the similar configurations as those of the steering control ECU 30 are denoted by the same reference numerals as those of the steering control ECU 30, and a description thereof will be omitted.

As illustrated in FIG. 5, an arithmetic unit 31A of the steering control ECU 30A includes a signal reading unit 312, a determination unit 313, an output unit 314, and a function restriction unit 311 as functional configurations. The storage unit 32A includes an ID storage unit 321 as a functional configuration.

The signal reading unit 312 reads a data frame input to the serial communication line 11a. The determination unit 313 determines whether or not the data frame read by the signal reading unit 312 is an illegal data frame. The determination unit 313 determines whether or not the read data frame is an illegal data frame based on an ID list stored in the ID storage unit 321. For example, the determination unit 313 determines that a data frame having an ID not included in the ID list in which the legal IDs are preliminarily listed is an illegal data frame. Also, the determination unit 313 determines that the data frame is an illegal data frame when the transmission source is an unknown ID, when the ID is an ID of a transmission source that exists but is not supposed to transmit it originally, or when the data frame having that ID is received in a cycle shorter than the stored transmission cycle by storing an approximate transmission cycle together with the ID received by itself. Further, the determination unit 313 can also determine whether or not the data frame is an illegal data frame input from a tampered ECU or an illegal external device by a known method and perform the determination based on the result.

When the determination unit 313 determines that the data frame is an illegal data frame, the output unit 314 transmits to the engine control ECU 20 and the display control ECU 40 a notification command data frame for commanding a predetermined notification operation of notifying the driver of the vehicle 1 of that the auxiliary torque (assist of steering power) by the steering device 3 is to be restricted. For example, the output unit 515 outputs the data frame of the first notification command to the engine control ECU 20 and outputs the data frame of the second notification command to the display control ECU 40. To the display control ECU 40, the data frame of the second notification command is output through a gateway 50.

When the determination unit 313 determines that the data frame is an illegal data frame, the function restriction unit 311 restricts the assist function for steering by the driver using the steering device 3.

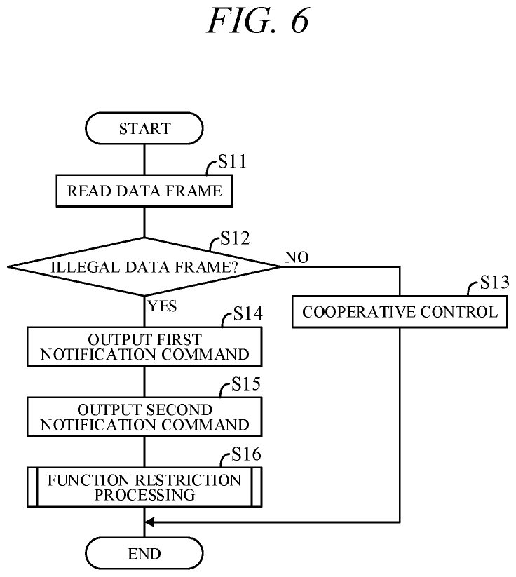

FIG. 6 is a flowchart illustrating an example of a process for an illegal data frame executed by the steering control ECU of FIG. 5. The process illustrated in FIG. 6 is started when inputting a data frame to the serial communication line 11a and is repeatedly executed.

First, in S11, an ID (identification information) of the input data frame is read by the processing in the signal reading unit 312. Next, in S12, it is determined whether or not the input data frame is an illegal data frame by the processing in the determination unit 313. If the result is negative in S12, cooperative control is executed in S13.

On the other hand, if it is affirmed in S12, in S21, the data frame of the first notification command is output to the engine control ECU 20 by the processing in the output unit 314. Next, in S15, the data frame of the second notification command is output to the display control ECU 40 by the processing in the output unit 314. Note that steps S14 and S15 may be executed simultaneously or in reverse order. Next, in S16, the function restriction unit 311 restricts the assist function for steering using the steering device 3.

In the embodiment described above, it is configured that the vehicle control apparatus 100 includes the gateway 50 and the steering control ECU 30, but the vehicle control apparatus may include a steering control unit that controls a steering motor and an illegal signal detection unit that detects an illegal signal input to an in-vehicle communication network.

In the embodiment described above, the rotation operation of the steering wheel 3a is assisted by adding the auxiliary torque corresponding to the rotation of the steering wheel 3a to the steering shaft 3c, but it is possible to configure that the rotation operation of the steering wheel 3a is assisted by adding the auxiliary torque corresponding to the rotation of the steering wheel 3a to the steering gear box 3d. That is, the steering motor may also be a turning motor.

The above embodiment can be combined as desired with one or more of the above modifications. The modifications can also be combined with one another.

According to the present invention, it is possible to prevent an unintended steering operation from occurring when an illegal signal is input to the in-vehicle communication network.

Above, while the present invention has been described with reference to the preferred embodiments thereof, it will be understood, by those skilled in the art, that various changes and modifications may be made thereto without departing from the scope of the appended claims.

What is claimed is:

1. A vehicle control apparatus, comprising:
a steering control unit connected to an in-vehicle communication network mounted on a vehicle and configured to control a steering motor configured to add an auxiliary torque corresponding to a steering operation by a driver to a steering mechanism; and
an illegal signal detection unit connected to the in-vehicle communication network and configured to detect an illegal signal input to the in-vehicle communication network, wherein
the steering control unit restricts the auxiliary torque when the illegal signal is detected by the illegal signal detection unit.

2. The vehicle control apparatus according to claim 1, wherein
when the illegal signal is detected by the illegal signal detection unit, the steering control unit restricts the auxiliary torque by reducing power supplied to the steering motor so that the power becomes lower than when the illegal data frame is not detected.

3. The vehicle control apparatus according to claim 1, wherein
the steering control unit restricts the auxiliary torque by stopping power supplied to the steering motor when the illegal signal is detected by the illegal signal detection unit.

4. The vehicle control apparatus according to claim 1, wherein
the steering control unit restricts the auxiliary torque after a notification operation for notifying the driver of torque restriction of the steering motor is performed.

5. The vehicle control apparatus according to claim 4, further comprising:
an engine control unit connected to the in-vehicle communication network and configured to control a rotational speed of an engine mounted on the vehicle, wherein
the steering control unit commands the engine control unit to reduce the rotational speed of the engine as the notification operation.

6. The vehicle control apparatus according to claim 4, further comprising:
a display control unit connected to the in-vehicle communication network and configured to control a display unit on an instrument panel mounted on the vehicle, wherein
the steering control unit commands the display control unit to display a predetermined indication on the display unit as the notification operation.

7. The vehicle control apparatus according to claim 1, wherein
the illegal signal detection unit is provided on a gateway unit configured to relay data signals transmitted between a plurality of units connected to the in-vehicle communication network.
